(19) United States
(12) Patent Application Publication
(10) Pub. No.: US 2014/0001187 A1
(43) Pub. Date: Jan. 2, 2014

(54) TRAYUCKET

(71) Applicant: Robert David Neumann, Dillon, CO (US)

(72) Inventor: Robert David Neumann, Dillon, CO (US)

(21) Appl. No.: 13/447,224

(22) Filed: Jun. 29, 2012

(51) Int. Cl. B44D 3/12

(52) U.S. Cl. 220/570

(57) ABSTRACT

A paint bucket that is quadrilateral in design and incorporates a type of screen or grid directly into the manufacturing of the product and is easily stackable.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF INVENTION

The present invention is in the class of Laundering, Cleaning or Drying Tools or Implements (D32) in the subclass of 53.1—Design for holding liquid pigment or stain mixtures.

The typical paint bucket (pint size to 5 gallons) is a round portable container that allows a person to hold as little or as much liquid as needed. It has high walls which at times makes it difficult to retrieve all of the liquid at the bottom of the bucket. Larger buckets (5 gallon) are difficult to move and require a separate screen to be attached to use a paint roller. This too makes it difficult to retrieve all of the paint from the bottom.

A flat paint tray is a portable container that is limited to holding one quart of liquid. It is not easy to move and is prone to spilling if not moved with care. The paint leveling area or grid does not allow you to level liquid onto the paint apparatus (paint roller) evenly.

### SUMMARY OF THE INVENTION

The present invention is a paint bucket that is quadrilateral in design and incorporates a type of screen or grid directly into the manufacturing of the product and is easily stackable.

### BRIEF DESCRIPTION OF THE DRAWINGS

FIG. 1 is a top view of the present invention looking into the bucket that shows the grids.

FIG. 2 is the end view of the exterior wall of showing the handle incorporated into the invention.

FIG. 3 is the side view of the paint container.

FIG. 4 is the bottom view of the paint container, showing that the container is stackable.

### DETAILED DESCRIPTION OF THE INVENTION

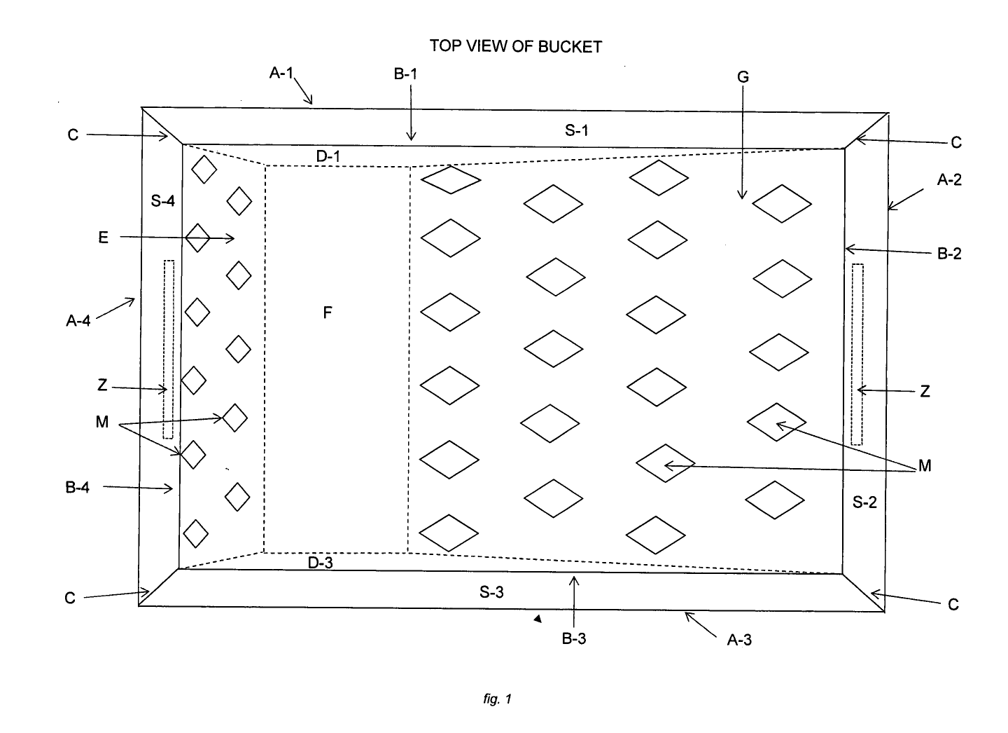

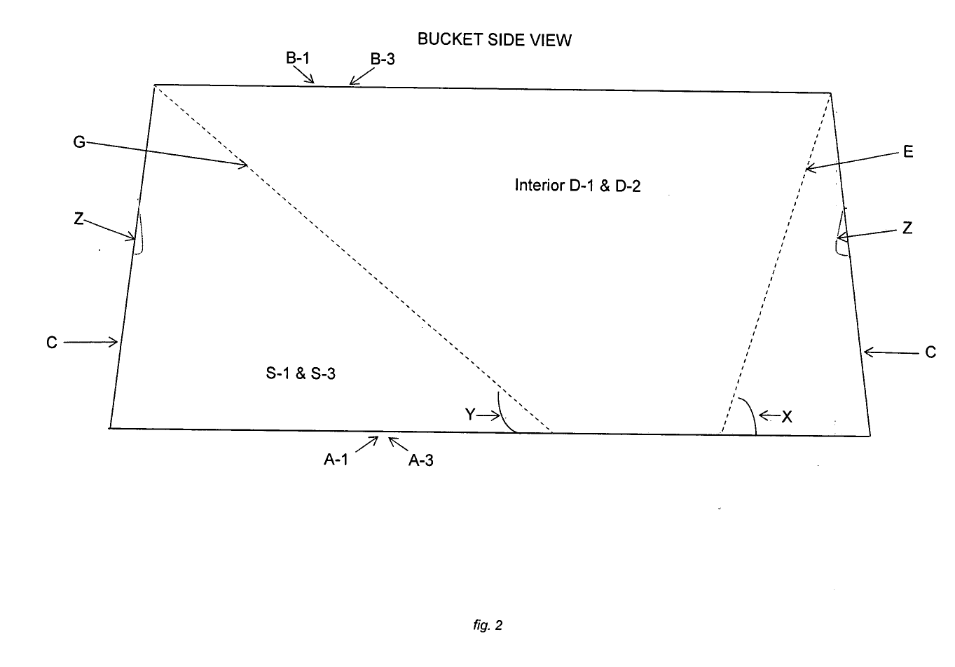

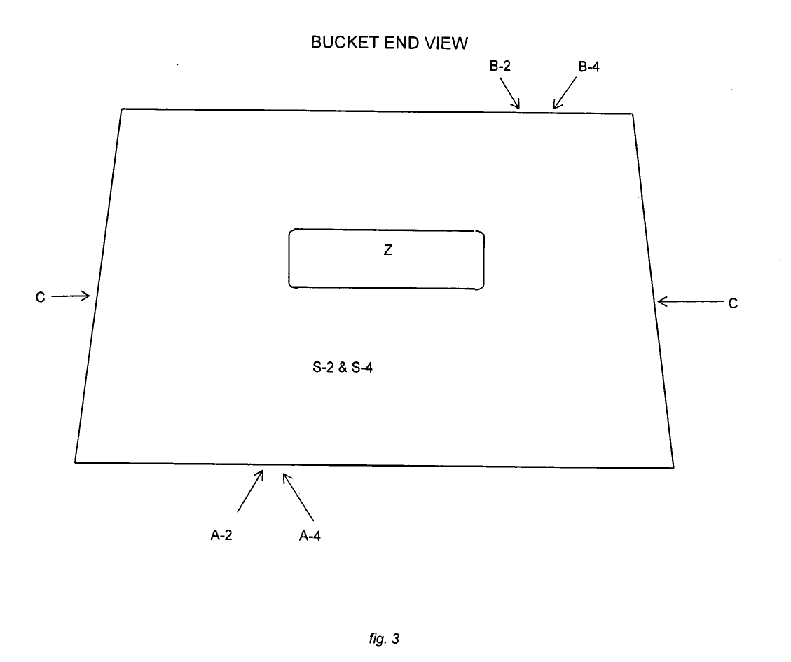

Referring now to the invention in more detail, in FIG. 1, there is shown a bucket's exterior with 4 sides in a quadrilateral, 2 sides of greater equal length (S-1 & S-2) with 2 sides of equal length (S-2 & S-4) yet shorter than S-1 & S-3. In FIG. 1, FIG. 2 and FIG. 3 the bottom of the bucket is represented by A-1 through A-4 and measures 18 inches in length (A-1 & A-3) and 13.5 inches in width (A-2 & A-4). Also in FIG. 1, FIG. 2, and FIG. 3 the top of the bucket is represented by B-1 through B-4 and measures 16 inches in length (B-1 & B-3) and 11.5 inches in width (B-2 & B-4).

Continuing to the exterior of the invention in FIG. 1, FIG. 2 and FIG. 3 each corner of the quadrilateral shaped bucket is represented by C. The height of the bucket at C is 9.5 inches.

Finally, referring to the exterior of the quadrilateral bucket in FIG. 1 FIG. 2, and FIG. 3 is a cut-out handle (Z) that is centered on each short end (S-2 & S-4) of the quadrilateral measuring 3 inches below the top of the apparatus (B-2 & B-4). The cut-out handles measure 4.5 inches in length and 1.5 inches in height.

In further detail of the invention, the interior of the bucket contains 2 leveling grids as evidenced in FIG. 1 and FIG. 2, as E and G. In FIG. 1, grid E is attached to S-4, however it could just as easily be shown as attached to S-2. In this model, grid E is 11.5 inches wide at the top at B-4 and is 10.5 inches at the bottom of F (FIG. 1 and FIG. 2). Grid E is at an angle of 108 degrees at F (see FIG. 2 at X).

Continuing with the interior of the invention, in FIG. 1 leveling grid G is attached to S-2, however as stated above, could as easily be attached to S-4. In this model, grid G is 11.5 inches at the top of B-2 and is 10.5 inches at the bottom of F (FIG. 1 and FIG. 2). Grid G (FIG. 1 & FIG. 2) is at an angle of 42 degrees with a length of 13⅜ inches from FIG. 1 and FIG. 2 B & F.

In more detail of the leveling grids referenced above (FIG. 1 X & Y), each grid has diamond shaped marks raised above each surface (FIG. 1 M). Each diamond shape mark is raised ¼ inch above the surface of the grid, is ½ inch in length and ¾ inch apart.

In further detail of the invention, the interior of the container is the bottom (F) in which the liquid sits. The bottom, F, is rectangular in shape and is 3.5 inches wide and 10.5 inches in length. F (FIG. 1 and FIG. 2) sits at the bottom of grids E & G (FIG. 1 and FIG. 2) and sides D-1 and D-2 (FIG. 1 and FIG. 2). The bottom sits on the same plane as A-1 through A-4 (FIG. 1, FIG. 2 and FIG. 3) so weight is on the floor and not easily spilled.

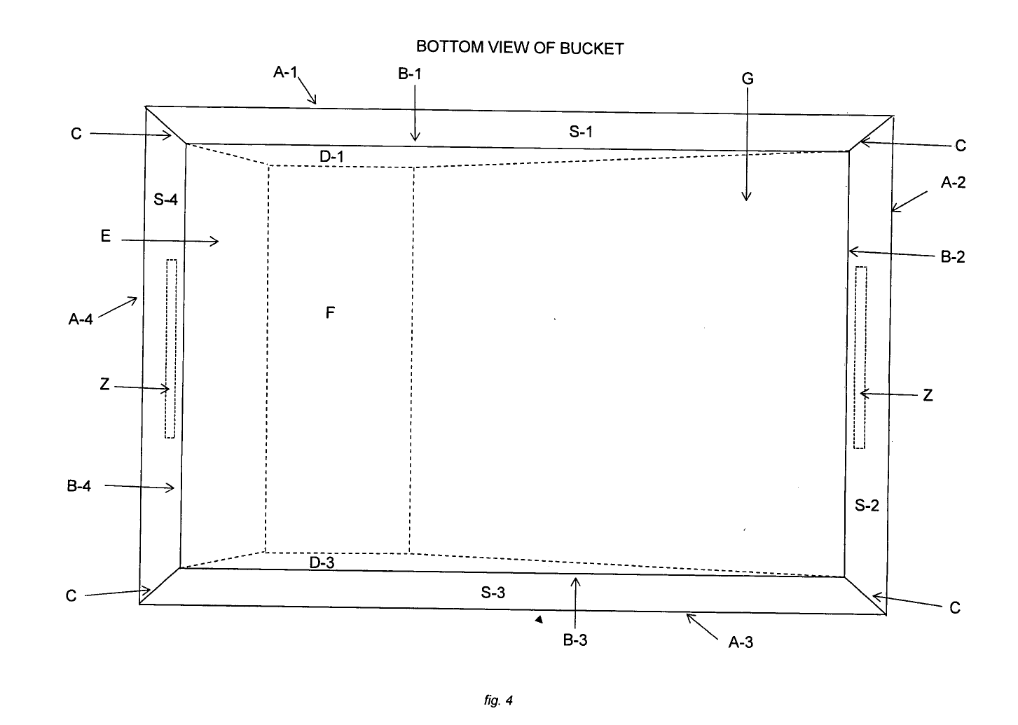

In additional detail to the apparatus, the bottom of the container is open under grids G and E (FIG. 4) allowing for stacking of multiple units.

The construction details of the invention as shown in FIG. 1, FIG. 2, FIG. 3, and FIG. 4 is made of high strength plastic, sufficient enough to hold 1 gallon of paint or stain. Further, all the components of the bucket can be made of different materials strong enough to hold a gallon of paint or stain.

The advantages of the present invention include, without limitation, that it is portable and easily transportable from one area to another. The grids that are constructed as part of the container allow for easier use of a roller without additional attachments (screens) as in a traditional bucket. In addition, traditional paint trays allow for a small amount of paint or stain and can be easily spilled when transported. The present invention allows for a greater amount of liquid that can be moved easily with less mess.

While the foregoing written description of the invention enables one of ordinary skill to make and use what is considered presently to be the best mode thereof, those of ordinary skill will understand and appreciate the existence and variations, combinations, and equivalents of the specific embodiment, method, and examples herein. The invention should therefore not be limited by the above described embodiment, method and examples, but by all embodiments and methods within the scope and spirit of the invention as claimed.

What is claimed is:

1. A portable apparatus for holding fluids, the apparatus is comprised of:
a) a singular combined unit containing an exterior shell and an interior container with 2 work areas or grids which is;
b) made of high strength material, rigid enough to carry the appropriate amount of liquid (paint or stain) in the interior for the size of the container.

2. Whereas as claimed in claim 1(a) the exterior shell is provided for support and to provide strength for an inner container.

3. The exterior shell as claimed in claim 1(a) has handles built in as cutouts maintaining it as a singular unit for ease of transport.

4. As claimed in claim 1(a) the bottom of the exterior shell of the container is of open construction which allows for stacking multiple containers when not in use.

5. As claimed in claim 1(a) & (b) the inner container has a holding area for liquids—paints and stains; in which the exterior of the interior container is separated from the exterior shell of the apparatus.

6. As claimed in claim 1(a) the inner container has 2 work areas have grids.

7. The grids according to claim 6 have raised surfaces which allow a user to spread the liquid evenly on to a paint brush or roller.
